(19) United States
(12) Patent Application Publication
(10) Pub. No.: US 2024/0081196 A1
(43) Pub. Date: Mar. 14, 2024

(54) EXTENDABLE WOODEN WALL PLANTER

(71) Applicant: Poon Wai Ling, Singapore (SG)

(72) Inventor: Poon Wai Ling, Singapore (SG)

(21) Appl. No.: 18/241,847

(22) Filed: Sep. 2, 2023

Related U.S. Application Data
(60) Provisional application No. 63/404,650, filed on Sep. 8, 2022.

(51) Int. Cl. A01G 9/12

(52) U.S. Cl. CPC A01G 9/12

(57) ABSTRACT

The present invention relates to a novel extendable wooden plant growth apparatus designed to accommodate plant growth and decorative displays. The apparatus is particularly suitable for use as a wooden wall planter, plant ladder, plant holder, or trellis. The key innovation lies in the use of interlocking rabbeted panels, namely top, middle, and bottom panel, which allow for easy extension and customization of the apparatus's length. These panels feature precision-cut rabbet grooves that securely join together to form an extended structure. Notably, the rabbeted joints are concealed, resulting in a visually seamless appearance when the apparatus is assembled. This invention provides users with the flexibility to adjust the length of the apparatus within specified increments, from 60 cm to 90 cm, 120 cm, 150 cm, and beyond, in multiples of 30 cm, thereby accommodating a wide range of plant growth and decorative needs. The apparatus combines aesthetic appeal, stability, and ease of assembly, making it a versatile and durable solution for both indoor and outdoor plant displays. In summary, this extendable wooden plant growth apparatus offers an innovative and practical approach to customizable plant display, promoting both functionality and visual harmony in plant-based decor.

### CROSS-REFERENCE TO RELATED APPLICATIONS

This patent application claims the benefit of U.S. Application No. 63/404,650 filed on Sep. 8, 2022.

### FIELD OF THE INVENTION

The present invention pertains to the field of plant growth apparatuses. Specifically, it relates to plant growing stands or structures with adjustables shelves that accommodate plant growth and can be extended by adding specific panels to achieve various lengths. The invention aims to provide an innovative solution within the realm of plant growth apparatus, particularly wooden wall planters, plant ladders, plant holders, or trellises that can be customized to different sizes while maintaining an aesthetically seamless experience.

### BACKGROUND OF THE INVENTION

Planters are more than just vessels for holding soil and plants; they are a fusion of horticulture and design, a bridge connecting nature with the man-made world. These versatile containers come in various shapes, sizes, and materials, each serving a unique purpose and offering distinct advantages. In this comprehensive article, we delve into the world of planters, exploring their types, uses, and the aesthetics they bring to gardens, homes, and landscapes.

At its core, a planter is a container designed to house plants, providing a controlled environment for their growth by enable gardening in spaces where direct ground planting isn't possible or desirable. They are a boon for urban dwellers, allowing them to cultivate greenery on balconies, patios, and rooftops. Planters are decorative elements that can elevate the visual appeal of any space. They introduce color, texture, and life to indoor and outdoor environments, turning them into inviting, tranquil settings. Depending on the material and design, planters can offer benefits like temperature regulation, moisture control, and ease of maintenance. Self-watering planters, for instance, ensure consistent hydration for your plants. Planters are more than just gardening accessories; they are expressions of creativity, style, and practicality. Whether you're an urban gardener with limited space or a landscaping enthusiast crafting intricate outdoor designs, there's a planter out there to meet your needs. These vessels bridge the gap between the built environment and nature, providing a canvas for your greenery to flourish while enhancing the beauty of your surroundings. Embrace the world of planters and watch as your space transforms into a lush, inviting haven.

Using planters for gardening can be convenient and aesthetically pleasing way to grow plants, but they also come with their own some disadvantages and potential problems like planters provide a finite amount of space for plant roots to grow. This can be a problem for plants that have extensive root systems or need a lot of room to grow, such as large trees or certain vegetables because restricted root space can stunt plant growth and development. Large planters, especially those made of heavy materials like stone or concrete, can be difficult to move once they are in place. This can be a problem if you need to relocate your plants for better sun exposure or protection from extreme weather. While planters can enhance the aesthetics of a space, they may not always blend seamlessly with the landscape or outdoor decor. Poorly chosen or mismatched planters can be visually unappealing. The size of a planter can limit the types of plants you can grow so large plants or those with extensive root systems may not thrive in smaller containers.

### SUMMARY OF THE INVENTION

The primary objective is to provide a plant growth apparatus including but not limited to wooden wall planter, plant ladder, plant holder, or trellis with a smart design that allows for easy extension without affecting its visual appeal. The invention employs a special hidden joining method to ensure that the finished product appears as a single, uninterrupted piece when installed on the wall. This aims to enhance the aesthetics of the apparatus.

Another significant objective is to provide a versatile solution that can cater to user's diverse needs. The invention is designed to extend into multiple different lengths, ranging from 60 cm to 90 cm, 120 cm, 150 cm, and beyond, in increments of 30 cm. Three specific panels top panel, middle panel, and bottom panel are provided to enable users to customize the length of the apparatus according to their specific requirements.

Ensuring the effectiveness and longevity of the extendable wooden plant growth apparatus is also a primary goal. The objective is to develop the apparatus using high-quality wood materials that maintain their durability and effectiveness over an extended period, providing a reliable and long-lasting solution for plant growth. In short, the objective of the invention revolve around creating a plant growth apparatus that is both visually appealing and versatile in terms of length customization while maintaining quality and durability over time.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE ACCOMPANYING DRAWINGS

The aforesaid as well as other objects and advantages of the invention will appear hereinafter from the following description taken in connection with the accompanying drawings in which:

FIG. 1 illustrates an exemplary embodiment of the top panel of the extendable wooden wall planter;

FIG. 2 illustrates an exemplary embodiment of the middle panel of the extendable wooden wall planter;

FIG. 3 illustrates an exemplary embodiment of the bottom panel of the extendable wooden wall planter;

FIG. 4 illustrates an assembled view of the wall planter in accordance with an embodiment of the present invention;

### DETAILED DESCRIPTION OF THE INVENTION

Additional features and advantages of the invention will be outlined in the description which follows, and in part will be obvious from the description, or may be learned by the practice of the invention. These and other features of the present invention will become more fully apparent from the following description or may be learned by the practice of the invention as set forth hereinafter.

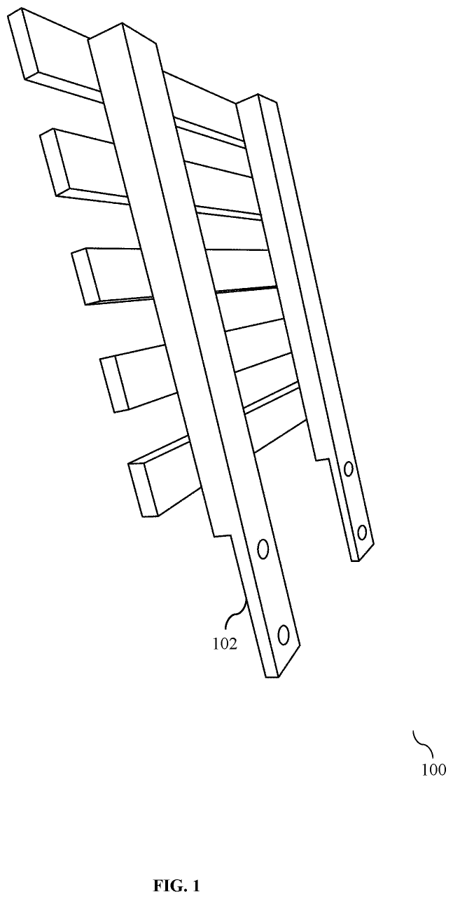

With reference now to the FIG. 1 thereof, an embodiment 100 of the top panel is disclosed which is primarily composed of high-quality wood, chosen for its durability, strength, and aesthetics qualities. The choice of wood may vary but should be suitable for outer use and able to withstand exposure to moisture and weather. In an embodiment of the present invention, the top panel typically measures approximately 40 cm in length. The exact dimensions may vary depending on the design and specifications of the apparatus, but it is designed to be compatible with middle panel and bottom panel for easy extension. The first panel features a rabbet groove 102 along its entire bottom edge of both the rails. In case of first panel, this rabbet groove 102 is designed to interlock with the rabbets 202 on rails of middle panel for easy extension.

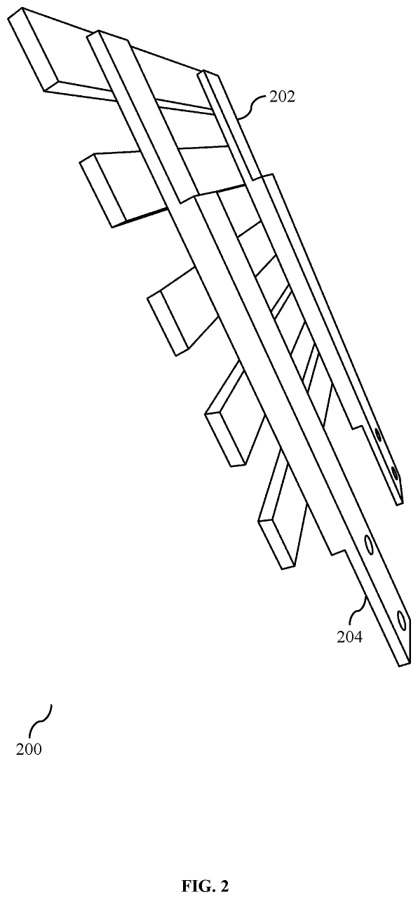

With reference now to the FIG. 2 thereof, an embodiment 200 of the middle panel is disclosed constructed from same high-quality wood material and typically measures approx 40 cm in length, similar to first panel and bottom panel. The middle panel is distinct in that it features rabbet grooves along both its top and bottom edges of the rails such that the rabbet groove 202 at the top is designed to interlock with top panel, while the rabbet groove 204 at the bottom is designed to interlock with bottom panel. Each rabbet is precisely cut to ensure a secure and snug fit. The middle panel is critical component of the apparatus, as it forms the central part of the assembly and plays a key role in securely connecting both top panel and bottom panel. The rabbet grooves on both the top and bottom edges of middle panel enable these connections to be seamless and robust, ensuring that the entire apparatus remains stable and visually appealing when extended.

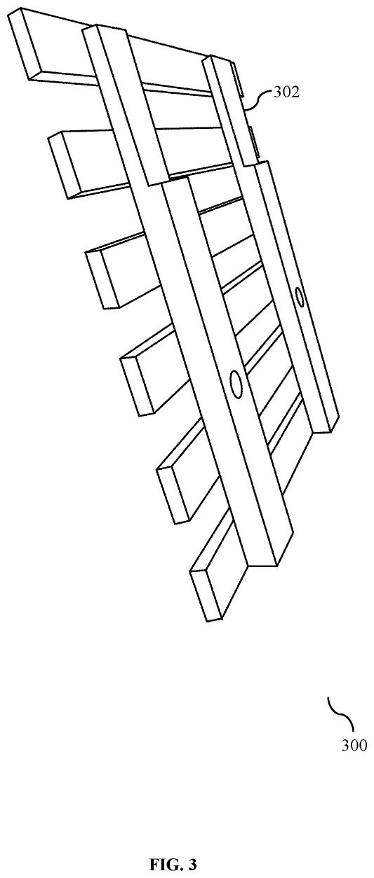

With reference now to the FIG. 3 thereof, an embodiment 300 of the bottom panel is disclosed which is crafted from the same high-quality wood material as top panel and middle panel. Similar to top panel and middle panel, bottom panel typically measures approximately 40 cm in length to ensure compatibility and ease of assembly when extending the apparatus. In an embodiment of the present invention, the bottom panel features a rabbet groove 302 on both rails along its entire top edge. In the case of bottom panel, the rabbet groove 302 at the top edge is designed to interlock securely with the rabbet groove 204 at the bottom of middle panel ensuring a snug fit.

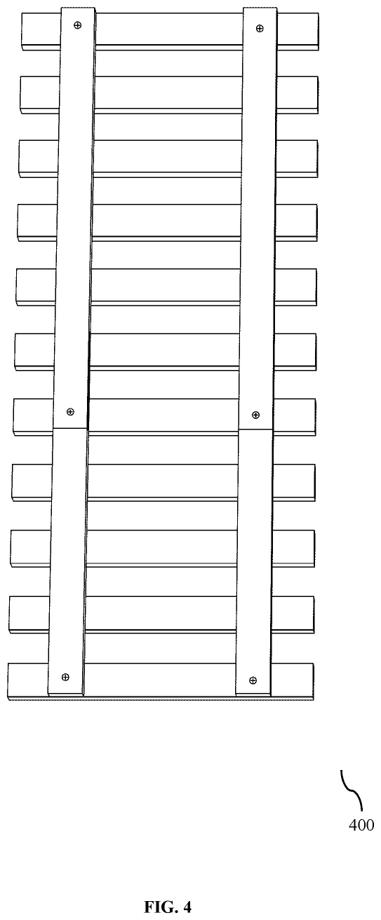

With reference now to the FIG. 4 thereof, an embodiment 300 of the fully assembled wooden wall planter apparatus is disclosed which results in an extended structure that seamlessly combines these components to create a functional and visually appealing plant growth apparatus. When all panels are properly aligned and connected, the apparatus presents a continuous wooden surface with no visible joints, gaps, or seams when viewed from the front. This continuous surface is one of the primary design objectives of the invention and contributes to its aesthetic appeal. wooden wall planter apparatus to achieve the desired extended length. The assembly of top, middle and bottom panel allows the users to achieve the desired extended length. In an embodiment of the present invention, the users can customize this length within the specified increments, such as 60 cm to 90 cm, 120 cm, 150 cm, or longer in multiples of 30 cm. The extension is achieved seamlessly, with the help of interlocking rabbet grooves on the rails of the panels. The rabbet grooves on the panels provide a secure and stable connection between each panel. This ensures that the entire apparatus remains stable even when it is loaded with plants, soil, or other items. The robust interlocking mechanism prevents any wobbling or instability.

The assembled apparatus appears as a single, cohesive unit when seen from front view since there are no visible lines or joints, creating a visually pleasing and harmonious design that enhances the overall aesthetics of the wooden wall planter apparatus. The extended wooden wall planter apparatus serves as a functional shelf for displaying potted plants, herbs, or other decorative items. It provides ample space for plant growth and allows users to create attractive vertical gardens or plant displays.

Depending on the wood type and additional treatments or finishes, the apparatus may exhibit weather-resistant properties, making it suitable for outdoor use. This ensures its durability and longevity when exposed to various environmental conditions. The choice of high-quality wood and potential weather-resistant treatments or finishes contributes to the overall durability of the apparatus. It is designed to withstand outdoor conditions and serve as a long-lasting solution for plant growth.

In an embodiment of the present invention, the panels may include identification markings, labels, or branding to indicate its role and compatibility within the extendable wooden wall planter apparatus or to provide information about its source or manufacturer.

The extendable wooden wall planter/plant ladder/plant holder/trellis disclosed above offer several advantages including but not limited to:
Customizable Length: Users can easily adjust the length of the plant growth apparatus to meet their specific needs, ranging from 60 cm to 90 cm, 120 cm, 150 cm, and beyond in increments of 30 cm. This customization allows for flexibility in plant placement and display.
Aesthetic Appeal: The hidden rabbet-based joining method ensures that there are no visible joints or seams when viewed from the front, providing a seamless and aesthetically pleasing appearance. This enhances the overall look of the wooden wall planter.
Stability and Strength: The interlocking rabbeted panels create a secure and stable connection, ensuring that the extended apparatus remains sturdy, even when bearing the weight of plants, soil, or other items. This stability reduces the risk of tipping or wobbling.
Easy Assembly: Users can assemble the apparatus without the need for specialized tools or fasteners. The intuitive design simplifies the assembly process, making it accessible to a wide range of users.
Versatile Use: The wooden wall planter apparatus can be used for various purposes, such as displaying potted plants, herbs, flowers, or decorative items. It allows for vertical gardening, maximizing limited space.
Durable Construction: The use of high-quality wood and potential weather-resistant treatments or finishes enhances the durability and longevity of the apparatus, making it suitable for both indoor and outdoor use.
Cost-Effective Shipping: The three-panel system (top, middle, and bottom panel), each measuring approximately 40 cm, reduces shipping costs and minimizes the risk of breakage during transportation resulting in cost savings for manufacturers and consumers.
Inventory Management: Manufacturing and inventory management are simplified because only three panels need to be produced and stocked, regardless of the desired length of the apparatus. This streamlined process improves efficiency and reduces production complexity.

In summary, the above invention offers a range of advantages, including customization, aesthetics, stability, ease of use, versatility, durability, cost-effectiveness, and environmental considerations. These benefits make it an innovative and practical solution for plant growth and decorative displays.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims. Additionally, the invention illustratively disclosed herein suitably may be practiced in the absence of any element which is not specifically disclosed herein—and in particular, embodiment specifically contemplated, is intended to be practiced in the absence of any element which is not specifically disclosed herein.

1. An extendable wooden wall planter apparatus, comprising:
a top panel having rabbet grooves along its bottom edge of the rails;
a middle panel having rabbet grooves along both its top and bottom edge of the rails;
a bottom panel having rabbet grooves along its top edge of the rails;
wherein said panels are capable of interlocking, allowing the apparatus to extend seamlessly without visible joints from the front view.

2. The extendable wooden wall planter apparatus according to claim 1, wherein the apparatus is customizable to various lengths by connecting top panel, middle panel, and bottom panel in different combinations, ranging from 60 cm to 90 cm, 120 cm, 150 cm, and beyond, in multiples of 30 cm.

3. The extendable wooden wall planter apparatus according to claim 1, wherein the rabbet grooves are precisely cut to ensure a snug and secure fit between the panels when assembled, resulting in a visually seamless appearance when the apparatus is assembled.

4. The extendable wooden wall planter apparatus according to claim 1, designed for use as a vertical gardening system, allowing for the display and growth of potted plants, herbs, flowers, or decorative items.

5. The extendable wooden wall planter apparatus according to claim 1, wherein the interlocking rabbeted panels create a stable and sturdy structure that remains secure even when loaded with plants, soil, or decorative items.

6. The extendable wooden wall planter apparatus according to claim 1, designed for ease of assembly, enabling users to connect top, middle and bottom panels without the need for specialized tools or hardware.

7. The extendable wooden plant growth apparatus according to claim 1, further comprising identification markings on one or more panels to indicate compatibility within the apparatus.

8. A method of assembling an extendable wooden plant growth apparatus comprising:
aligning top panel with middle panel, interlocking the rabbet groove on bottom edge of rails of the top panel with the rabbet groove on the top edge of the middle panel;
aligning bottom panel with middle panel, interlocking the rabbet groove on top edge of the rails of bottom panel with the rabbet groove on bottom edge of the rails of the middle panel;
whereby the interlocking rabbet grooves create a seamless and stable extension of the apparatus.

9. The method of assembling an extendable wooden wall planter apparatus according to claim 7, wherein the length of the assembled apparatus is adjusted by adding or removing panels, accommodating various lengths based on user preferences.

10. The method of assembling an extendable wooden wall planter apparatus according to claim 7, wherein the assembled apparatus provides a continuous wooden surface without visible joints when viewed from the front.
